(19) United States
(12) Patent Application Publication
(10) Pub. No.: US 2026/0217258 A1
(43) Pub. Date: Jul. 30, 2026

(54) DRIVER MONITORING SYSTEM AND METHOD

(71) Applicant: HEARTRAY LTD, Kibutz Haogen (IL)

(72) Inventors: Eran HOCHSTADTER, Kibbutz Haogen (IL); Ran CALIFA, Givatayim (IL); Matan BENYAMIN, Givatayim (IL)

(21) Appl. No.: 19/146,330

(22) PCT Filed: Jan. 9, 2024
(86) PCT No.: PCT/IL2024/050034

§ 371 Date: Jul. 8, 2025

Related U.S. Application Data
(60) Provisional application No. 63/437,751, filed on Jan. 9, 2023.
(60) Provisional application No. 63/523,154, filed on Jun. 26, 2023.

(51) Int. Cl. B60W 40/08; G06V 10/141; G06V 10/75; G06V 20/59; G06V 40/16; G06V 40/18

(52) U.S. Cl. CPC B60W 40/08; G06V 10/141; G06V 10/751; G06V 20/597; G06V 40/171; G06V 40/18; B60W 2040/0872; B60W 2420/403; B60W 2540/221

(57) ABSTRACT

A system for monitoring biomedical parameters and a corresponding method are described. The system comprises a light source arrangement providing a coherent illumination pattern generating illumination spots on body surface of the individual, a camera unit collecting images the coherent illumination spots, and a control unit comprising at least one processor. The control unit receives input data comprising color images and processes the input data to determine one or more biomedical parameters of the individual. The processing comprises: determining temporal overlap between acquisition time and a selected pulse sequence of illumination and selecting a sequence of images having overlap above a selected threshold. Processing said sequence of images and identifying pixels associated with the coherent illumination spots. Generating a contrast varying functions indicative of variation in contrast of the speckles and determining one or more biomedical parameters of the individual based on the contrast varying functions.

### TECHNOLOGICAL FIELD

The present disclosure relates to systems and method for monitoring biomedical parameters of an individual and relates specifically to monitoring one or more parameters of one or more individuals within the vehicle.

### BACKGROUND

Driver monitoring system (DMS) is a vehicle safety system used for analyzing and monitoring Driver's condition, and alert or take actions to reduce risk of crash of the vehicle. Typical DMS utilizes one or more camera units and control system operable for collecting and analyzing data on driver's attention, alertness, and possibly other biomedical conditions.

DMS systems are considered as high-level safety system for road vehicles. Such systems enter the list of required safety system to provide reliable monitoring of driver's alertness and awareness. This is of specific importance in vehicles utilizing assistive driving functions.

VCSEL technology has become an increasingly popular choice for implementation in automotive production due to its high power, robustness, and cost-effectiveness. Further VCSELs' structure results in narrow bandwidth as compared to LED, providing improved temporal coherence and signal to noise ratio when needed. The use of VCSEL light source further enables selective filtering to avoid disturbance from ambient illumination, focusing on the narrow emission bandwidth of the VCSELs. In recent years, a driving monitoring system (DMS) has been developed to provide real-time evaluation of the presence and state of the driver. This DMS includes a camera-based system pointed at the driver's face to provide alerts to the driver and initiate an intervention to manage the control of the vehicle when necessary. This technology helps to improve safety on the road and provides better control over the vehicle.

Speckle patterns are patterned of light and dark regions formed within illuminated spot due to coherence of light. Speckles are typically considered as noise, however various techniques are known, utilizing speckle analysis for remote monitoring of selected parameters. Laser Speckle Contrast Analysis (LASCA) is a technique enabling monitoring and analysis of blood perfusion and blood flow in tissue based on variation in contrast of speckle patterns. This technique enables determining data such as heart rate, heart rate variability, blood perfusion, and in some cases even blood pressure and breathing rate.

### GENERAL DESCRIPTION

Driver monitoring systems are increasingly becoming essential safety elements in vehicles. Typical driver monitoring systems often utilize image processing to determine driver conditions and alert levels to enhance road safety.

Monitoring biomedical and physiological parameters of the driver can provide valuable data on driver's condition. Speckle analysis, and specifically Laser Speckle Contrast Analysis (LASCA) technique enable remote and contactless collection of biomedical and physiological parameters such as heart rate, heart rate variability (HRV), breathing rate, blood perfusion level and more.

Determining such parameters using spackle analysis generally requires coherent illumination, giving rise to spackle patterns due to self-interference between light components. The present disclosure provides a light source unit configured to provide an illumination pattern comprising coherent illumination, while being adapted for use in typical vehicle space and integration with existing and typical driver monitoring systems (DMS). It should be noted that the system of the present disclosure and a driver monitoring system utilizing the technique of the present disclosure may also be use in off-road environments. Such systems may be used in cars, tractors, trains, airplanes, boats, or any vehicles moving in or on land, water, and air. Further, the system may be installed within a helmet with required size and range modifications.

The present disclosure provides a system for monitoring one or more biomedical and/or physiological parameters of an individual. The system is generally configured to operate within a driver monitoring system configuration and provide combined functionalities in detection and assessment of driver's alertness, position, gaze direction etc., and to provide suitable alert if needed.

The system of the present disclosure provides for monitoring one or more biomedical parameters of one or more individuals, typically a driver and/or passengers. The system comprising a light source arrangement emitting an illumination pattern comprising one or more coherent illumination beams, and typically also certain incoherent illumination. The system further comprises a camera unit configured to obtain color images of a selected region, which is aligned with a region illuminated by the light source arrangement. Additionally, the system comprises a control unit, comprising at least one processor and memory, and carrying computer readable instructions that when executed by the processor cause the control unit to perform tasks as described herein. Generally, the control unit is adapted to operate the light source arrangement for generating a selected pulse sequence for illumination a selected region, operate the camera for collecting image data from the selected region, and to receive the image data pieces from the camera unit. The control unit operates to analyze the image data pieces and determine images associated with selected illumination conditions suitable for analysis of driver's awareness and other images suitable for determining biomedical data of the driver and/or one or more passengers. Typically, the control unit can classify image data pieces based on temporal overlap with a selected illumination sequence. Thus, image data pieces classified for driver awareness analysis maintain desired image quality. This is while suitable coherent illumination pattern is used for speckle analysis and detection of biomedical and/or physiological parameters based on image data pieces classified for this purpose. The present disclosure thus provides enhanced functionality and may be implemented within driver monitoring systems at relatively low cost.

Thus, according to a broad aspect, the present disclosure provides a system for monitoring biomedical parameters of an individual, the system comprising:
(a) a light source arrangement providing at least a coherent illumination pattern for generating one or more coherent illumination spots on body surface of said individual;
(b) a camera unit operable for collecting one or more color images, positions to collect image data from a scene, said one or more color images comprise at least a first sub-sequence of images comprising said one or more coherent illumination spots;
(c) a control unit comprising at least one processor adapted for operating said light source arrangement and said camera unit, and for receiving input data comprising one or more color images from the camera unit, and for processing said input data to determine one or more biomedical parameters of said individual;
wherein said processing comprises: determining temporal overlap between acquisition time of color images in said input data and a selected pulse sequence of illumination emitted by said light source arrangement and selecting a sequence of images having overlap above a selected threshold, processing said sequence of images and identifying pixels associated with said one or more coherent illumination spots on body surface of said individual, generating a contrast varying functions indicative of variation in contrast of speckles in the coherent illumination spots in said sequence of images, and determining one or more biomedical parameters of an individual based on the one or more contrast varying functions.

According to some embodiments, the light source arrangement comprises an array of single mode VCSEL units configured to emit a plurality of coherence illumination beams to generate said one or more coherent illumination spots on body surface of said individual.

According to some embodiments, the light source arrangement is configured to generate said one or more coherent illumination spots on body surface of said individual in a selected wavelength being between 800 nm and 1100 nm.

According to some embodiments, the light source arrangement further comprises one or more arrays of VCSEL unit comprising multimode VCSEL units.

According to some embodiments, the light source arrangement further comprises one or more LED light sources.

According to some embodiments, the camera unit comprises a RGB sensor.

According to some embodiments, the camera unit comprises an RGB-IR sensor, carrying RGB pixels and Infrared sensitive pixels.

According to some embodiments, the camera unit comprises a partial bandpass spectral filter configured to transmit near IR illumination at one or more selected wavelength ranges and reduce intensity of visible range light to enhance detection of near IR illumination in color images.

According to some embodiments, the camera unit is operable in variable exposure rate for acquiring image data, said camera unit being operable in an image collection pattern comprising at least one sub-pattern synchronized with illumination sequence of said one or more coherent illumination spots for collecting said sequence of images.

According to some embodiments, the image collection pattern further comprises one or more sub-sequences of image acquisition comprising images suitable for image processing.

According to some embodiments, said image processing comprises one or more of head detection, eye tracking, body positioning detection, blink detection, and facial key point identification.

According to some embodiments, the system may be configured as a driver monitoring system (DMS), wherein said individual is a driver of a vehicle.

According to some embodiments, the system may be configured as a driver monitoring system (DMS) and/or passenger monitoring system, wherein said individual is at least one passenger of a vehicle.

According to some embodiments, the light source system may further comprise one or more incoherent light sources operable for at least one of flood illumination and spatially separated pattern illumination.

According to some embodiments, the one or more color images comprise one or more second sub-sequence of color images associated with incoherent illumination.

According to some embodiments, the light source arrangement comprises one or more VCSELs selectively operable to emit incoherent illumination in accordance with modulation to input electrical current to the VCSELs.

According to one other broad aspect, the present disclosure provides a method comprising:
(a) providing image data sequence of a region of interest comprising at least a portion of body of an individual, and providing data indicative of sequence of coherent illumination pulses emitted by a light source arrangement;
(b) processing said image data sequence and determining a sub-sequence of images having temporal overlap with said sequence of coherent illumination pulses;
(c) processing said sub-sequence of images and determining one or more illumination spots associated with coherent illumination within said sub-sequence of images;
(d) utilizing said one or more illumination spots and determining a measure of contrast variations between images of said sub-sequence, determining a contrast varying function indicative of contrast variation of said one or more illumination spots within said sub-sequence of images, and determining one or more biomedical parameters of an individual based on said contrast varying function.

According to some embodiments, the method may further comprise determining a plurality of two or more contrast varying function associated with two or more illumination spots in said sub-sequence of images, for each of said contrast varying function determining a time varying quality factor, and wherein said determining one or more biomedical parameters of said individual comprises selecting contrast varying functions having quality factor above a selected threshold within one or more respective time window.

According to some embodiments, the data indicative of sequence of coherent illumination pulses emitted by a light source arrangement comprises data on sequence of operation of an array of single mode VCSEL units configured to emit a plurality of coherence illumination beams to generate said one or more coherent illumination spots on body surface of said individual.

According to some embodiments, the method may further comprise operating said light source arrangement in a first mode providing coherent illumination and in a second mode to provide incoherent illumination.

According to some embodiments, the method may further comprise operating the light source arrangement in the second mode comprises providing the light source arrangement modulated input electrical current to enhance linewidth of emitted light and reduce coherence thereof.

According to some embodiments, the coherent illumination pulses emitted by a light source arrangement comprises illumination in a selected wavelength between 800 nm and 1100 nm.

According to some embodiments, the image data sequence comprises color images.

According to some embodiments, the image data sequence comprises images collected using an RGB-IR sensor, carrying RGB pixels and Infrared sensitive pixels. The method of any one of claims 16 to 21, wherein said image data sequence comprises images collected through a partial bandpass spectral filter configured to transmit selected one or more near IR wavelength ranges and reduce intensity of visible range light to enhance detection of near IR illumination in color images.

According to some embodiments, the image data sequence comprises images collected using variable exposure rate for acquiring image data, wherein said sub-sequence of images being synchronized with said sequence of coherent illumination pulses emitted by said light source arrangement.

According to some embodiments, the exposure time for images associated with said sequence of coherent illumination pulses is in a range between 50 s and 300 s.

According to some embodiments, the image data sequence comprises one or more second sub-sequences of images collected for use in image processing.

According to some embodiments, the exposure time for sub-sequence of image data directed for DMS is in a range between 0.5 ms and 5 ms.

According to some embodiments, the method may further comprise processing said one or more second sub-sequences of images for one or more of head detection, eye tracking, body positioning detection, blink detection, and facial key point identification.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a system according to some embodiments of the present disclosure;

FIGS. 2A and 2B exemplify light source arrangement according to some embodiments of the present disclosure including single mode VCSEL array (FIG. 2A) and combined VCSEL array including single mode and multimode sub-arrays (FIG. 2B);

FIG. 3 exemplifies a temporal illumination pattern according to some embodiments of the present disclosure;

FIG. 4 exemplifies image data classification based on illumination pattern according to some embodiments of the present disclosure;

FIG. 5 exemplifies machine learning based processing of a plurality of contrast variation functions according to some embodiments of the present disclosure;

FIGS. 6A and 6B exemplify spectral response functions of a RGB camera, FIG. 6A shows the spectral response function and typical illumination wavelengths and FIG. 6B also shows a bandpass filter according to some embodiments of the present disclosure;

FIG. 7 exemplifies a modified Bayer filter according to some embodiments of the present disclosure; and

FIG. 8 illustrates a method according to some embodiments of the present disclosure in a way of a block diagram.

### DETAILED DESCRIPTION OF EMBODIMENTS

As indicated above, the present disclosure provides a system and methos usable for detection of biological, biomedical and/or physiological parameters of an individual. The present technique provides for monitoring Vital signs including Heart Rate (HR), Inter beat interval (IBI), Heart rate variability (HRV), Respiration waveform, Respiration Rate (RR), and Blood perfusion (BP) of an individual, and is generally configured to be operable within a vehicle as a part of a vehicle management system, including road and/or off-road use. More specifically, the present disclosure provides a driver monitoring system with known functionalities such as driver awareness and gaze detection data, and allows for additional functionality that can be used to detect the stress of the driver's medical condition wellness, fatigue, Thermal comfort of the driver and so on without, or with minimal compromising on data quality.

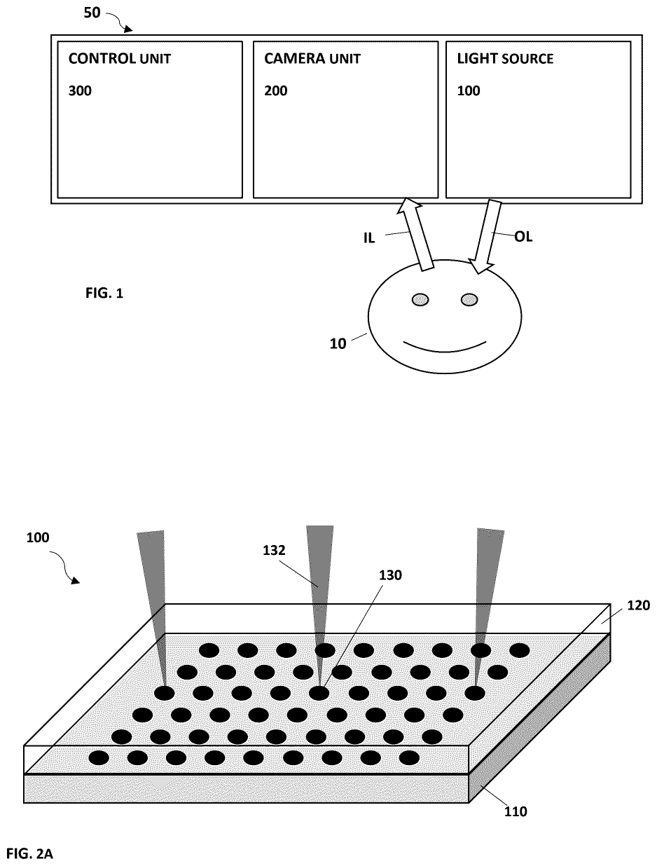

In this connection reference is made to FIG. 1 illustrating schematically a system 50 according to some embodiments of the present disclosure. System 50 may be configured to be mounted within a vehicle for monitoring driver's awareness and selected biomedical and/or physiological parameters of the driver. The system 50 includes at least one light source 100, at least one camera 200 and a control unit 300. Generally, the at least one light source 100 is operable for generating a selected illumination pattern OL, including one or more of spatial and temporal pattern, directed at a region where driver 10 and optionally one or more passengers are located. The at least one camera unit is configured and operable for collecting image data pieces including the illuminated region, at a selected imaging rate, and with selected (optionally variable) exposure times. The camera unit 200 thus collects image data pieces including reflected illumination pattern IL. the control unit 300, typically including at least one processor and memory, and carrying selected computer readable instructions, is configured to receive image data pieces from the camera 200 and process the image data pieces to determine one or more parameters of at least one individual 10. The control unit 300 thus operable for processing the image data pieces including one or more sequences of image data pieces, for remotely monitoring certain characteristics of an individual 10.

In this connection it should be noted that certain image processing and/or cutting actions may be performed within the camera 200 itself. For example, in some embodiments, the camera 200 may be operates in a cropping mode to transmit image portions associated with one or more selected regions of the image, including relevant data on features such as speckle patterns, driver face region, driver forehead, cheeks or other body portions. The use of cropped image data may provide for saving data transmission bandwidth within the system.

Such image cropping function may be performed for different image pieces in accordance with image sequence and/or illumination sequence. For example, the image sequence may include image data pieces collected for speckle analysis and image data pieces collection for general DMS analysis. In such DMS image data pieces, the camera 200 may operate to crop selected image portions for image processing and determine one or more frame regions where speckle pattern analysis may provide enhanced data, such as forehead of one or more persons in a vehicle. The camera may utilize such data to improve image cropping for use in speckle analysis and simplify image processing and volume of data transmission. Also, as indicated herein, images directed for spackle analysis are generally collected using coherent illumination while images directed for DMS analysis are generally collected with ambient or incoherent illumination.

In this connection, the system 50 of the present disclosure is preferably configured to provide DMS functions and can be provided as an add-on, including hardware and/or software features to a DMS. For example, the light source arrangement 100 is generally an illumination unit that directs coherent illumination onto a specific area of the subject's 10 body, creating one or more illumination spots. Further, the light source arrangement 100 may also provide flood illumination and/or further illumination pattern providing desired imaging conditions enabling the control unit to determine driver's parameters.

Further, the camera 200 is generally a color camera, e.g., including a RGB sensor or Bayer filter. The camera 200 is preferably also configured to collect near infrared data, enabling detection of additional parameters and allowing the use of infrared illumination pattern to protect driver's eyes and avoid distractions while driving. The camera 200 is generally configured to operate with a selected frame rate (e.g., 60-150 fps) and may utilize constant and/or variable exposure time for different image data pieces.

Generally, image data pieces (frames) can be split into a selected ratio between first sub-sequence associated with coherent illumination and detection of biomedical parameters, and one or more second sub-sequences for DMS use. For example, the camera 200 may be operable at frame rate of 60-150 fps, where the frames can be split equally between the channels to support 30-75 fps for each sub-sequence, or unevenly, for example, 10 fps for video and 50 fps for vitals or any other ratio. Selection of frame rate division may be determined in accordance with system's load and further requirements. More specifically, during stressed driving that system may determine that the driver's attention to driving is relatively low and increase DMS frame rate. Alternatively, if driver's biomedical parameters are close to, or exceed, a selected threshold for vital signs, additional frames are directed at this processing. It should be noted that selection of frame rate division also affects illumination pattern that may be varied accordingly.

The control unit 300 operates the light source arrangement 100 and the camera unit 200 as described above. The control unit further operates to received input image data from the camera unit and to process the input image data using two of more processing paths. More specifically, the control unit may determine for each image piece, data on illumination pattern associated with the image, images collected with flood illumination are used for image processing such as gaze detection and other DMS processing tasks; images collected with illumination pattern for depth detection are used for three-dimensional detection processing; and images collected with coherent illumination are used for speckle detection and analysis, to determine one or more biomedical and/or physiological parameters of people in the vehicle.

Generally, the control unit 300 may include at least one processor and memory unit, and respective input/output modules implemented in hardware and/or software protocols. The control unit 300 stored computer readable instructions, which, when executed by the processor cause the control unit to operate and to generate operational instructions to the light source arrangement 100 and/or camera 200 as described herein. Such operations may be implemented as hardware and/or software models and are described herein as being comprises within the control unit.

Further, typically the control unit may be operable for various DMS functionalities including monitoring driver's attention using eye- or gaze-detection, head orientation, blinking frequency etc., and may be configured to generate an alert if driver's is detected to reduce driving attention below selected thresholds. Additionally, as described herein, the control unit may further include computer readable instructions for determining and monitoring one or more biomedical and/or physiological parameters of the driver and/or other passengers in the vehicle.

In this connection reference is made to FIGS. 2A and 2B exemplifying light source arrangements according to some embodiments of the present disclosure. FIG. 2A schematically illustrating light source unit 100 configured to provide a coherent illumination pattern according to some embodiments of the present disclosure. The light source unit 100 includes a substrate 110, typically made as a multilayer substrate having a layered arrangement forming a vertical cavity. The substrate carries a plurality of single mode VCSELs 130, operable for emitting optical radiation in a selected wavelength range. The light source unit 100 also includes an optical element 120, such as a lens array, diffractive optical element, etc., configured for manipulating output beams 132 of the single mode VCSELs to provide an arrangement of generally collimated beams propagating in a non-parallel relation toward a selected region, to thereby generate a selected illumination pattern of the selected region.

FIG. 2B illustrates a combined light source unit 100 according to further some embodiments of the present disclosure. This this example, a common chip 110 carries an array of single mode VCSELs 130 and an additional array of multimode VCSELs 150. The single mode VCSELs are associated with optical element 120 as described above to provide an array of non-parallel, generally collimated output beams 132. The array of multimode VCSELs may also be associated with an optical element 124, and is configured to generate output light in the form of a plurality of output beams 152. Illumination pattern of the multimode VCSELs array 150 may be selected to provide spatially separated light spots to support three-dimensional analysis of the illuminated region. Alternatively, as illustrated in FIG. 2B, the illumination pattern may include overlapping output beams generating flood illumination suitable for general image processing operated by a typical DMS system.

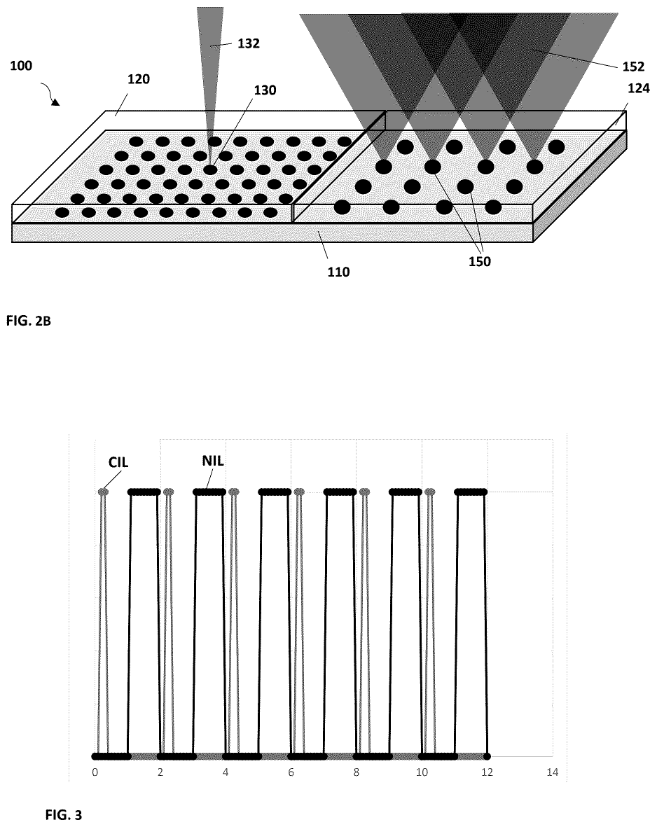

Typically, in some embodiments, light source unit 100 and/or multimode VCSELs array 150, may be operable to eliminate, or at least significantly reduce speckle contrast while providing flood illumination. To eliminate or at least reduce speckle contrast, coherence properties of light components emitted by the different VCSELs should be mitigated to reduce coherence between the different VCSELs 150. The coherence of the VCSELs can be intentionally diminished by providing high-frequency modulation of the operating input electrical current to the VCSELs. For example, the current modulation may be at rates of 50 kHz or above. The electrical current modulation may be below and/or above the lasing threshold and may be both above and below the lasing threshold. This modulation to input electrical current increases in the laser linewidth to a range of 3-4 nm, resulting in a corresponding reduction in coherence. In some embodiments, input electrical current modulation may be used on VCSEL array 130 as well during time period directed at flood illumination, e.g., when operating a single VCSEL array 130 as exemplified in FIG. 2A. The current modulation may be used in selected times, for example as exemplified in FIG. 3 indicating periodic modulation between coherence illumination and incoherent illumination times. The use of modulation of input electrical current to the VCSEL array 130 and/or 150 may provide for dynamic operation of the light source arrangement 100 based on selected and/or specific requirements thereby enhancing functionality and effectiveness of the driver monitoring system.

Further, in some additional embodiments, light source arrangement may also include one or more LED light sources of selected wavelength ranges. Such LED light source may be used in addition to the array of single mode VCSELs as illustrated in FIG. 2A and/or in addition to the combined single mode and multimode VCSELs array illustrated in FIG. 2B.

An example of temporal operation pattern of the light source arrangement is illustrated in FIG. 3. As shown, the illumination pattern may include a sequence of short periods (e.g., 50-300 μs) of coherent illumination CIL and a sequence of longer periods (e.g., 3-30 ms) of generally incoherent illumination NIL. In some embodiments, the illumination sequence may include a sequence of incoherent flood illumination suitable of general image processing, gaze detection etc., and a sequence of illumination pattern formed of spatially separated illumination spots suitable for three-dimensional mapping of the illuminated region. It should be noted that flood illumination may be used during nighttime or in dark illumination conditions, while in daylight conditions it may not be needed and accordingly may be turned off. Generally as indicated above, the incoherent illumination NIL periods may be achieved using modulation of input electrical current to the VCSEL array, used for increasing VCSELs linewidth thereby reducing coherence of light emitted by the VCSELs in the array.

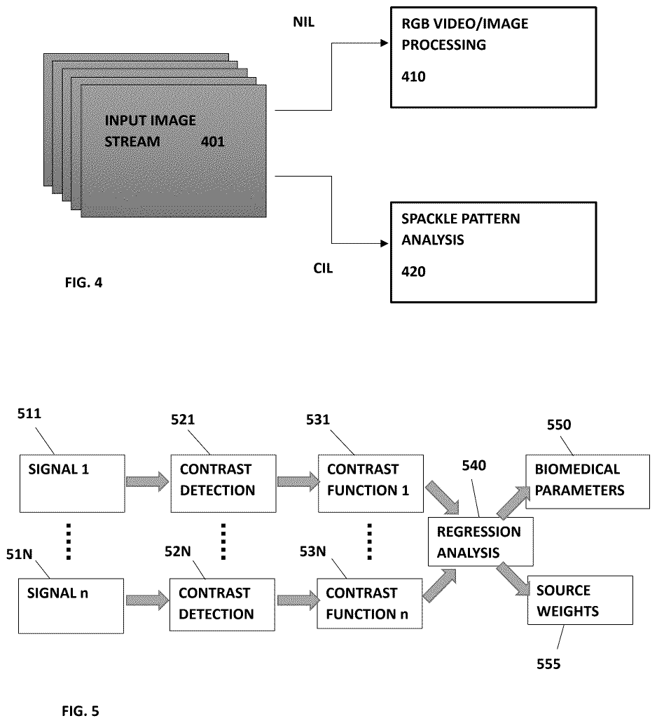

Generally, the control unit 300 may operate the light source arrangement with a selected illumination sequence. Further, the control unit 300 operates the camera 200 at a selected frame rate and selected exposure time for each frame. This enables the control unit 300 to classify image data pieces as relating to specific illumination conditions. FIG. 4 exemplifies image sequence classification according to some embodiments of the present disclosure. As illustrated, image sequence 401 is collected by the camera 200 and transmitted to the control unit 300. The control unit operates to classify the image data pieces based on temporal overlap with illumination sequence as relating to coherent illumination sequence CIL, or as relating to “normal” illumination NIL, including e.g., no illumination, flood illumination and/or other illumination patterns. The control unit 300 operates for processing “normal” illumination images in accordance with various DMS processing requirements such as gaze detection, driver awareness, face recognition, etc. Further, the control unit 300 operates for processing coherently illuminated image sequence using spackle pattern analysis for detection of biomedical and/or physiological parameters such as heart rate, heart rate variability, breathing rate, blood perfusion, etc.

It should be noted that number of frames associated different sub-sequences may be dynamically determined based on various requirements such as road safety and driver attention.

In this connection, the control unit 300 may operate for processing the CIL image data pieces using speckle contrast analysis (LASCA). More specifically, the control unit may operate for detecting one or more coherent illumination spots within the image data, and determine contrast of speckle pattern in the identified illumination spots. The control unit 300, or processor thereof, operates for determining for the identified coherent illumination spots, a contrast varying functions that relates to variation in contrast of the speckle pattern between image data pieces collected at different time. Contrast variation in the spackle patterns may be indicative of small vibrations or movements of the surface on which the speckle pattern is detected. Accordingly, for speckle patterns detected on body surface of an individual, e.g., the driver, the contrast variation may be indicative of capillary blood perfusion, and other physiological variations in the body surface. Using known processing techniques, such as Fourier transform and frequency analysis, the control unit 300 may determine biomedical parameters of the driver.

Generally, the processor may utilize various image processing technique, that are typically associated with DMS functionalities, such as face recognition, gaze detection head and/or eye tracking, key points on face, body posture, etc., for enhancing ability to identify speckle patterns and contrast thereof. Further, as the image data used for speckle analysis is based on color (RGB) image data, such processing functionalities are readily implementable based on control unit architecture and algorithms.

As illustrated in FIGS. 2A and 2B, the light source arrangement may preferably provide an illumination pattern formed of a plurality of coherently illuminated spots. This provides the control unit 300 with a plurality of speckle patterns suitable for spackle pattern analysis and determined biomedical parameters. Accordingly, the processor may operate to determine a plurality of contrast varying functions associated with a respective plurality of illumination spots. To improve quality of biomedical data determined based on the speckle contrast analysis, the control unit may also operate to determine quality factor for each of the contrast varying functions. Such quality factor may vary with time as the driver moves his body, head orientation shifts, illumination changes etc., thus the quality factor may be determined as time varying quality factor. Using quality assessment of the different contrast varying functions, in accordance with time varying quality factor of each function, the control unit may determine an aggregated spackle contrast function and based determining biomedical parameters of the driver or passengers thereon.

For example, the aggregated spackle contrast function may be determined based on one or more contrast varying functions having quality factor above a selected threshold at the time. Additionally, or alternatively, the control unit may utilize one or more machine learning (ML) or artificial intelligence (AI) processing to collect the plurality of contrast varying function signals and extract a pure physiological signal. Such ML/AI technique may utilize one or more regression models receiving signals with temporal duration T, from N number of face areas.

General operation of the ML/AI processing is exemplified in FIG. 5. The processor initially identifies a plurality of signals indicative of speckle patterns 511 to 51n associated with respective plurality of illumination spots. for each signal, the processor determines varying contrast 521-52n and determines a contrast function 531-53n. The plurality of varying contrast functions 531-53n are provided as input to a regression model 540 to determine a selected vector of biomedical parameters 550 based on speckle contrast analysis and vector of weights for each of the sources.

The regression model may be trained using supervised or unsupervised training. In some preferred embodiments, the regression model may undergo unsupervised training forcing the model to represent a signal and a clean spectral estimation of the signal, close to each other in an embedding space. This way, the model may use coherent spectral features of the signal, which characterize the physiological component of the signal more than the noise components thereof.

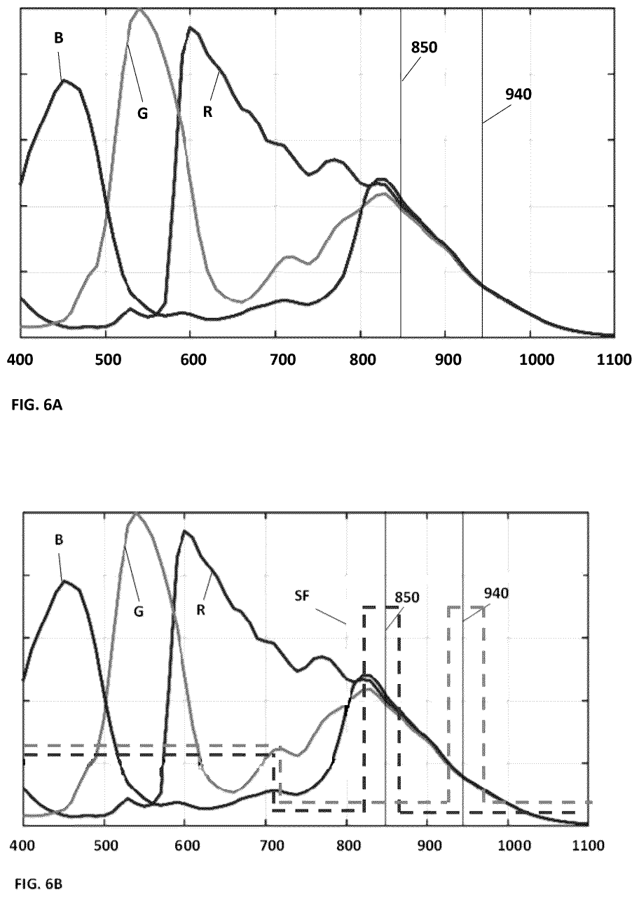

Further, as indicated above, the system 50 of the present disclosure utilizes a color (e.g., RGB) camera 200. further, as mentioned above, the light source arrangement 100 may provide general illumination using one or more LEDs, and/or multimode VCSEL array 150 for general illumination purposes, and array of single mode VCSELs 130 to provide coherent illumination pattern that give rise to spackle patterns for detection of biomedical parameters. The single mode VCSEL array 130 is generally operable to emit infrared illumination in one or more selected wavelengths between 800 nm and 1100 nm. This is to provide suitable illumination that does not distract the driver's attention. FIGS. 6A and 6B exemplify spectral response of typical RGB camera and exemplify optional infrared illumination wavelengths of 850 nm and of 940 nm on the spectral response curves.

As exemplified in FIG. 6A, RGB Bayer filter includes pixels having different spectral response with maximal transmission respectively around 450 nm, 540 nm, and 600 nm. Further, as shown, the different filters have generally similar transmission for infrared wavelengths between about 820 nm and up to 1100 nm. Thus, when operating at selected wavelengths between 800 nm and 1100 nm, collection efficiency of the RGB camera is generally similar between the pixels. To overcome the lower response to infrared wavelength with respect to ambient visible light, the camera may operate at reduced exposure times for collecting image data associated with coherent illumination. For example, exposure time of images aligned with coherent illumination may be of length of 50-300 μs, in accordance with illumination pulse length. More specifically, returning back to FIG. 3, the camera 200 may operate with exposure time that matches short illumination pulses for coherent illumination CIL and with longer exposure time for the longer general illumination NIL.

In some further embodiments, the camera 200 may utilize a bandpass filter SF as illustrated in FIG. 6B. The bandpass filter may include one or more transmission bands and lower collection intensity for other wavelength ranges. For example, as illustrated in FIG. 6B, the bandpass filter may allow transmission around selected wavelengths such as 850 nm and 940 nm and reduce transmission for visible wavelengths below 800 nm. The bandpass filter reduced camera sensitivity to visible light and increases sensitivity to infrared illumination, enhancing detection of the speckle patterns in collected image data pieces.

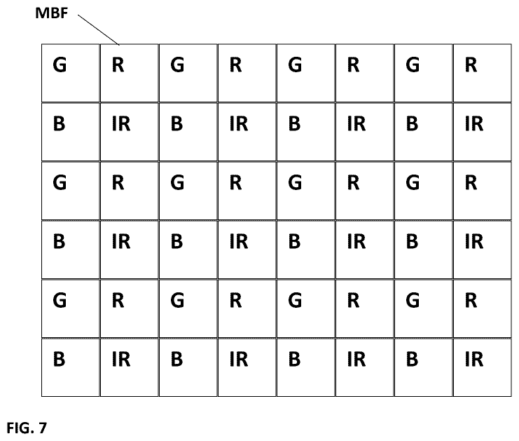

An alternative configuration of the camera 200 is exemplified in FIG. 7 illustrating a modified Bayer filter MBF. The modified Bayer filter includes RGB pixels, while half of the green pixels are replaced by infrared transmitting filters, providing image pixels that are specifically selected for imaging in infrared illumination. Using modified Bayer Filter MBF as exemplified in this figure allows the system of the present disclosure to obtain the respective pixels' data for processing in spackle analysis as described above, and the RGB pixels' data for other image processing associated with DMS functionality.

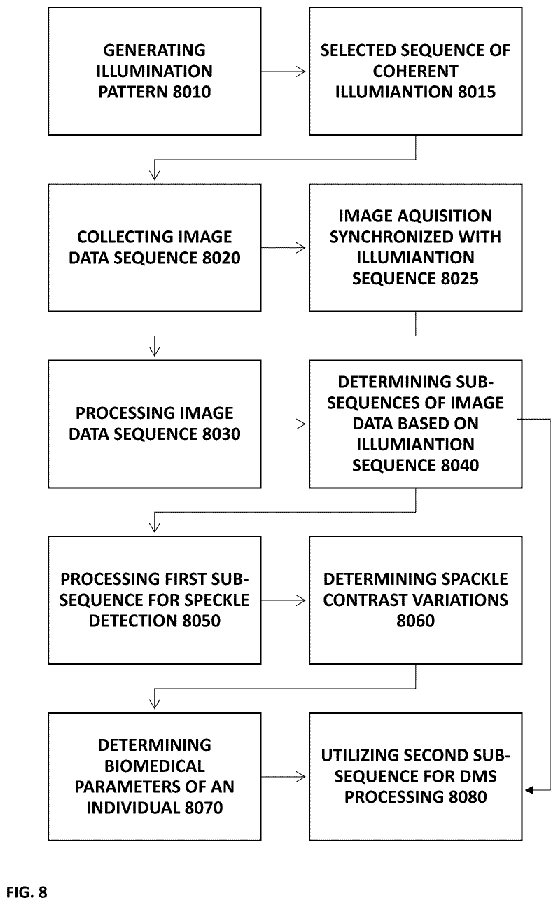

As indicated above, the technique of the present disclosure may be implemented by operation of the control unit, including one or more processor and memory, and carrying computer readable instructions as described herein. In this connection reference is made to FIG. 8 exemplifying main operational actions of the present disclosure. As shown, the method includes operating a light source arrangement for generating an illumination pattern 8010. The illumination pattern may include at least one sequence of coherent illumination 8015, and may also include one or more sequences of incoherent illumination such as flood illumination to provide proper imaging conditions and/or selected illumination pattern to support three-dimensional mapping. In parallel with the illumination pattern, the method includes operating a camera for collecting image data sequence 8020. Preferably, operation of the camera in image acquisition may be synchronized with the illumination sequence 8025. For example, as indicated above, exposure times of the camera may be aligned with illumination periods of selected illumination conditions, and specifically of coherent illumination conditions. For example, exposure time of images aligned with coherent illumination may be of length of 50-300 μs, in accordance with illumination pulse length.

The method further includes processing the image data sequence 8030. The processing includes determining one or more sub-sequences of image data based on illumination conditions 8040. Generally, a first sub-sequence relates to image data pieces collected during coherent illumination sequence. Additionally, the image data sequence may include one or more second sub-sequences, associated with flood illumination (or natural illumination) and/or with spatially separated illumination spots pattern.

The first sub-sequence is processed for detection of illumination spots having speckle patterns therein 8050, and for determining speckle contrast variations over time 8060 through the first sub-sequence. The method may utilize ML and/or AI processing for determining a common signal sequence indicative of a person's biomedical parameters (e.g., driver and/or passengers), and/or utilize processing for determining quality factor of contrast variation functions between speckle patterns determined in different illumination spots. Using various contrast variation functions, the method operates to determine one or more biomedical parameters of one or more individuals in the vehicle 8070. Such parameters may include heart rate, heart rate variability, breathing rate, blood perfusion, etc.

Operating in parallel with processing of the first sub-sequence of the image data, the method of the present disclosure may also operate for processing one or more of second sub-sequences in accordance with selected DMS processing 8080. The DMS processing may be a typical DMS processing operating for detection of driver attention and focus levels and generate alerts if needed.

Detection of biomedical parameters provides additional level to DMS and enhances the systems functionality. Detection of heart rate and heart rate variability allow the system to generate an alert if the driver is overly calm or overly stressed. The system may also be used to monitor additional passengers in a vehicle based on alignment of the illumination pattern and field of view of the camera.

The present disclosure thus provides a system, method, computer implemented method and/or program product, operable for providing data on one or more biomedical and/or physiological parameters of one or more individuals. The system of the present disclosure is generally adapted to be used within a vehicle, operating for monitoring driver's attention and awareness levels, and to utilize monitoring of spackle patterns in addition to typical DMS processing.

1. A system for monitoring biomedical parameters of an individual, the system comprising:
(a) a light source arrangement providing at least a coherent illumination pattern for generating one or more coherent illumination spots on body surface of said individual;
(b) a camera unit operable for collecting one or more color images, positioned to collect image data from a scene, said one or more color images comprise at least a first sub-sequence of images comprising said one or more coherent illumination spots;
(c) a control unit comprising at least one processor adapted for operating said light source arrangement and said camera unit, and for receiving input data comprising one or more color images from the camera unit, and for processing said input data to determine one or more biomedical parameters of said individual;
wherein said processing comprises: determining temporal overlap between acquisition time of color images in said input data and a selected pulse sequence of illumination emitted by said light source arrangement and selecting a sequence of images having overlap above a selected threshold, processing said sequence of images and identifying pixels associated with said one or more coherent illumination spots on body surface of said individual, generating a contrast varying functions indicative of variation in contrast of speckles in the coherent illumination spots in said sequence of images, and determining one or more biomedical parameters of an individual based on the one or more contrast varying functions.

2. The system of claim 1, wherein said light source arrangement comprises an array of single mode VCSEL units configured to emit a plurality of coherence illumination beams to generate said one or more coherent illumination spots on body surface of said individual.

3. The system of claim 1, wherein said light source arrangement is configured to generate said one or more coherent illumination spots on body surface of said individual in a selected wavelength being between 800 nm and 1100 nm.

4. The system of claim 2, wherein said light source arrangement further comprises one or more arrays of VCSEL unit comprising multimode VCSEL units.

5. The system of claim 2, wherein said light source arrangement further comprises one or more LED light sources.

6. (canceled)

7. The system of claim 1, wherein said camera unit comprises an RGB-IR sensor, carrying RGB pixels and Infrared sensitive pixels.

8. The system of claim 1, wherein said camera unit comprises a partial bandpass spectral filter configured to transmit near IR illumination at one or more selected wavelength ranges and reduce intensity of visible range light to enhance detection of near IR illumination in color images.

9. The system of claim 1, wherein said camera unit is operable in variable exposure rate for acquiring image data, said camera unit being operable in an image collection pattern comprising at least one sub-pattern synchronized with illumination sequence of said one or more coherent illumination spots for collecting said sequence of images.

10. The system of claim 9, wherein said image collection pattern further comprises one or more sub-sequences of image acquisition comprising images suitable for image processing, and wherein said image processing comprises one or more of head detection, eye tracking, body positioning detection, blink detection, and facial key point identification.

11. (canceled)

12. The system of claim 1, configured as a driver monitoring system (DMS), wherein said individual is a driver of a vehicle or at least one passenger of a vehicle.

13. (canceled)

14. The system of claim 1, wherein the light source system further comprises one or more incoherent light sources operable for at least one of flood illumination and spatially separated pattern illumination.

15. The system of claim 1, wherein said one or more color images comprise one or more second sub-sequence of color images associated with incoherent illumination.

16. The system of claim 1, wherein the light source arrangement comprises one or more VCSELs selectively operable to emit incoherent illumination in accordance with modulation to input electrical current to the VCSELs.

17. A method comprising:
(a) providing image data sequence of a region of interest comprising at least a portion of body of an individual, and providing data indicative of sequence of coherent illumination pulses emitted by a light source arrangement;
(b) processing said image data sequence and determining a sub-sequence of images having temporal overlap with said sequence of coherent illumination pulses;
(c) processing said sub-sequence of images and determining one or more illumination spots associated with coherent illumination within said sub-sequence of images;
(d) utilizing said one or more illumination spots and determining a measure of contrast variations between images of said sub-sequence, determining a contrast varying function indicative of contrast variation of said one or more illumination spots within said sub-sequence of images, and determining one or more biomedical parameters of an individual based on said contrast varying function.

18. The method of claim 17, further comprising determining a plurality of two or more contrast varying function associated with two or more illumination spots in said sub-sequence of images, for each of said contrast varying function determining a time varying quality factor, and wherein said determining one or more biomedical parameters of said individual comprises selecting contrast varying functions having quality factor above a selected threshold within one or more respective time window.

19. The method of claim 17, wherein said data indicative of sequence of coherent illumination pulses emitted by a light source arrangement comprises data on sequence of operation of an array of single mode VCSEL units configured to emit a plurality of coherence illumination beams to generate said one or more coherent illumination spots on body surface of said individual.

20. The method of claim 17 further comprising operating said light source arrangement in a first mode providing coherent illumination and in a second mode to provide incoherent illumination.

21. (canceled)

22. The method of claim 17, wherein said coherent illumination pulses emitted by a light source arrangement comprises illumination in a selected wavelength between 800 nm and 1100 nm.

23. (canceled)

24. The method of claim 17, wherein said image data sequence comprises images collected using an RGB-IR sensor, carrying RGB pixels and Infrared sensitive pixels.

25. (canceled)

26. The method of claim 17 wherein said image data sequence comprises images collected using variable exposure rate for acquiring image data, wherein said sub-sequence of images being synchronized with said sequence of coherent illumination pulses emitted by said light source arrangement.

27. (canceled)

28. (canceled)

29. (canceled)

30. (canceled)
